(19) United States
(12) Patent Application Publication
(10) Pub. No.: US 2026/0169288 A1
(43) Pub. Date: Jun. 18, 2026

(54) METHOD FOR MANUFACTURING A COMPONENT FOR A BACKLIGHTING DEVICE, AND ASSOCIATED COMPONENT FOR A BACKLIGHTING DEVICE, BACKLIGHTING DEVICE, IMAGE GENERATION DEVICE, AND HEAD-UP DISPLAY

(71) Applicant: VALEO COMFORT AND DRIVING ASSISTANCE, Créteil (FR)

(72) Inventors: François Grandclerc, Créteil (FR); Arnaud Husson, Créteil (FR)

(73) Assignee: VALEO COMFORT AND DRIVING ASSISTANCE, Créteil (FR)

(21) Appl. No.: 18/837,050

(22) PCT Filed: Jan. 20, 2023
(86) PCT No.: PCT/EP2023/051451

§ 371 Date: Aug. 8, 2024

(30) Foreign Application Priority Data
Feb. 8, 2022 (FR) FR2201099

(51) Int. Cl. G02B 27/01

(52) U.S. Cl. CPC G02B 27/0101

(57) ABSTRACT

A process for manufacturing a backlighting-device component comprises the following steps: depositing a coating layer on a reflective polarizer, said reflective polarizer comprising a multilayer optical film, printing patterns in the coating layer in such a way that said printed coating layer forms an optical diffuser. A backlighting-device component, a backlighting device, an image-generating device, and a head-up display are disclosed herein.

The present invention relates in general to the field of displays.

It more particularly relates to a process for manufacturing a backlighting-device component, which is for example used in a motor-vehicle head-up display, and to such a backlighting-device component, backlighting device, image-generating device, and head-up display associated therewith.

Typically, a so-called “head-up” display forms a virtual image in the field of view of a motor-vehicle driver. The latter is thus able to view information relating to the operation of the vehicle, relating to a traffic lane ahead of the vehicle and so on without having to avert her or his gaze from this traffic lane to do so. Specifically, the virtual image, containing the information to be displayed, is then superposed visually on the environment ahead of the vehicle.

Generally, a so-called “head-up” display comprises, inside a housing, an image-generating device from which a source light beam emerges and a projecting optical system that is configured to project an image generated by the image-generating device toward the driver of the vehicle, via the windshield for example, so as to form the aforementioned virtual image.

Head-up displays for motor vehicles using a liquid-crystal display (LCD) in their image-generating device are often exposed to two types of thermal stresses that cause the screen to heat up: one of these stresses is associated with the light source of the head-up display, and the other with concentration of solar rays on the display.

Such image-generating devices often comprise elements laminated on one another that are not very resistant to high temperatures.

In this context, the present invention provides a process for manufacturing a backlighting-device component comprising the following steps:
depositing a coating layer on a reflective polarizer, said reflective polarizer comprising a multilayer optical film,
printing patterns in the coating layer in such a way that said printed coating layer forms an optical diffuser.

Manufacturing the component by depositing the coating layer then printing the latter makes it possible to avoid a laminating step and thus to produce a component that is more resistant to high temperatures.

In one embodiment, the optical diffuser has an angular distribution the full width at half maximum of which is less than 45 degrees with respect to a principal direction of diffusion.

In one embodiment, the coating layer is made of a material that polymerizes under ultraviolet radiation. It is then possible, for example, to make provision to subject the coating layer to ultraviolet radiation in the step of printing the patterns (in order to harden the coating layer then containing the patterns).

In one embodiment, the reflective polarizer further comprises at least one polycarbonate layer deposited on the multilayer optical film.

For example, the reflective polarizer comprises a further polycarbonate layer, the at least one polycarbonate layer and the further layer being placed on either side of the multilayer optical film.

In one embodiment, the at least one polycarbonate layer is diffusing.

For example, the at least one polycarbonate layer has a diffusion angle of 2 degrees.

In one embodiment, the at least one polycarbonate layer is adhesively bonded to the multilayer optical film by means of a layer of optical adhesive.

For example, the dimensions and shape of the patterns are defined on the basis of the angular distribution of the optical diffuser.

One of the aspects of the invention also relates to a backlighting-device component comprising:
a reflective polarizer on a first side, said reflective polarizer comprising a multilayer optical film,
an optical diffuser on a second side opposite the first side,
wherein the optical diffuser is a coating layer comprising printed patterns.

In one embodiment, the reflective polarizer further comprises at least one polycarbonate layer deposited on the multilayer optical film.

For example, the at least one polycarbonate layer is adhesively bonded to the multilayer optical film by means of a layer of optical adhesive.

For example, the reflective polarizer comprises a further polycarbonate layer, the at least one polycarbonate layer and the further layer being placed on either side of the multilayer optical film.

For example, the at least one polycarbonate layer is diffusing.

For example, the optical diffuser has an angular distribution the full width at half maximum of which is less than 45 degrees with respect to a principal direction of diffusion.

Another aspect of the invention relates to a backlighting device comprising:
a light source configured to emit a source beam,
a reflector configured to reflect at least a part of the source beam into a reflected beam,
a component according to the invention,
wherein the first side of the component is placed facing the light source so as to intercept at least a part of the reflected beam.

Another aspect of the invention relates to an image-generating device comprising a backlighting device according to the invention, characterized in that it further comprises a liquid-crystal display placed downstream of the reflector on the path of propagation of the light.

Lastly, one of the aspects of the invention relates to a head-up display comprising an image-generating device according to the invention, further comprising a projecting optical system able of steering a light beam generated by the image-generating device in the direction of a partially transparent blade.

Of course, the various features, variants and embodiments of the invention may be associated with one another in various combinations provided that they are not mutually exclusive or incompatible.

In addition, various other features of the invention will become apparent from the accompanying description that is provided with reference to the drawings, which illustrate non-limiting embodiments of the invention, and in which:

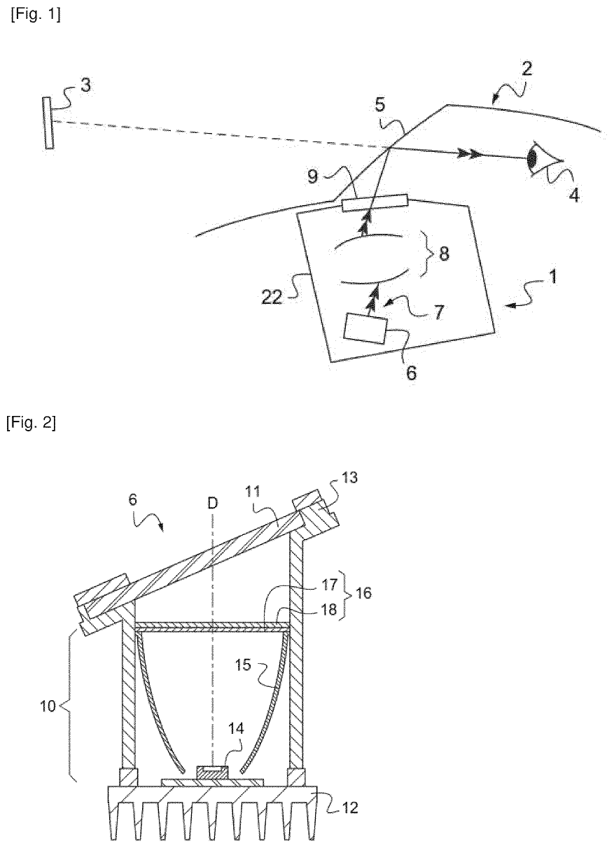

FIG. 1 is a schematic view showing the integration of a head-up display according to the invention into a motor vehicle;

FIG. 2 shows one embodiment of a backlighting device according to the invention;

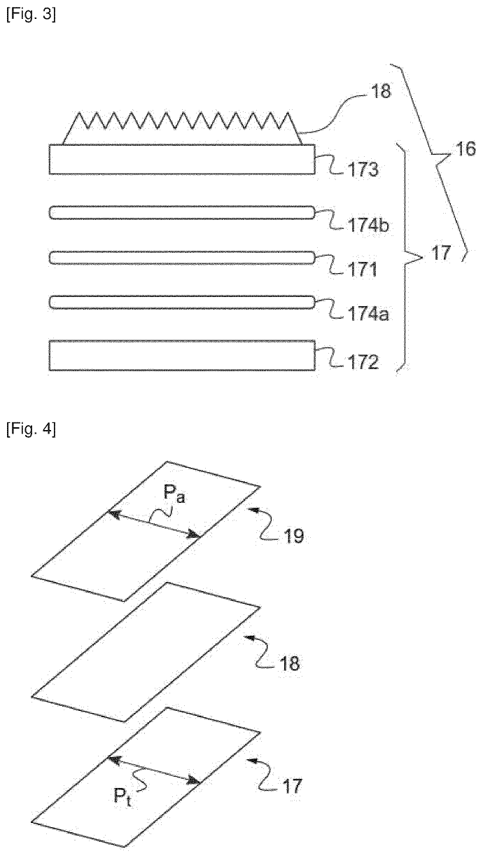

FIG. 3 shows a backlighting-device component according to the invention;

FIG. 4 schematically shows the arrangement of certain components of an image-generating device according to the invention; and

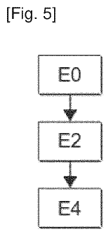

FIG. 5 shows the main steps of a process for manufacturing the backlighting-device component according to the invention.

It should be noted that in these figures structural and/or functional elements common to the various variants may have the same reference signs.

FIG. 1 schematically shows the main elements of a head-up display 1 intended, for example, to be fitted in a vehicle 2, in particular a motor vehicle.

The display 1 of FIG. 1 is configured to project a virtual image 3 into the field of view of a driver 4 of the vehicle 2, such that the driver 4 may see this virtual image 3 and any information that it contains without having to avert her or his gaze.

To this end, the display 1 comprises a partially transparent blade 5 placed in the field of view of the driver 4, an image-generating device 6 configured to generate an image light beam 7 and a projecting optical system 8 configured to steer, in the direction of said partially transparent blade 5, the image light beam 7 generated by the image-generating device 6 after passing through a transparent window 9. The light beam steered in the direction of the partially transparent blade 5 is partly reflected by the partially transparent blade 5 in the direction of the driver 4 and thus produces the virtual image 3.

The partially transparent blade 5 is here the windscreen of the vehicle 2. In other words, it is the windscreen of the vehicle 3 that acts as the partially transparent blade 5 for the purposes of the head-up display 1.

As may be seen in FIG. 1, the image-generating device 6 and the projecting optical system 8 are here placed in a housing 22, an aperture of which is closed by the transparent window 9 mentioned above.

One embodiment of the image-generating device 6 according to the invention is illustrated in FIG. 2. The image-generating device 6 comprises a backlighting device 10, a liquid-crystal display 11 covering the backlighting device 10, a first heat sink 12 and a second heat sink 13.

The backlighting device 10 comprises a light source 14 in the light-emitting diodes matrix, a reflector 15 and an optical component 16. The light source 14 is configured to emit a source beam that is divergent around a principal direction D. The reflector 15 receives at least a part of the source beam and reflects at least a part thereof into a beam reflected in the direction of the optical component 16. The reflected beam is here collimated. The optical component 16 receives at least a part of the reflected beam and transmits at least a part thereof in a diffused beam toward the liquid-crystal display 11. The diffused beam illuminates the liquid-crystal display 11 so that the liquid-crystal display 11 may allow at least a part of the diffused beam to pass to form the image light beam 7.

FIG. 3 shows one embodiment of the structure of the optical component 16. The optical component 16 comprises a reflective polarizer 17 on a first side and an optical diffuser 18 on a second side opposite the first side. By reflective polarizer, what is meant is a polarizer operating in reflection, i.e. that reflects a determined polarization component Pd. By optical diffuser, what is meant is an optical element that causes angular spreading of incident light.

The reflective polarizer 17 consists of a multilayer optical film 171 fastened by adhesive bonding to a first polycarbonate layer 172 on one side and to a second polycarbonate layer 173 on the opposite side by means of two layers of optical adhesive 174a and 174b. The multilayer optical film 171 consists of a stack of dielectric layers. For example, the multilayer optical film 171 comprises more than 100 atomic layers, for example between 100 atomic layers and 500 atomic layers, here 180 atomic layers, and/or has a thickness of between 20 microns and 200 microns, here 70 microns. Moreover, the first polycarbonate layer 172 and the second polycarbonate layer 173 are here (slightly) diffusing. Typically, the first polycarbonate layer 172 and the second polycarbonate layer 173 each have an angular distribution the full width at half maximum of which is equal to 2 degrees with respect to a principal direction of diffusion. For example, the principal direction of diffusion is the direction normal to the plane of the first polycarbonate layer 172 and of the second polycarbonate layer 173.

In a first variant, the reflective polarizer 17 consists of a multilayer optical film 171 fastened by adhesive bonding to a first polycarbonate layer 172 on one side and to a second polycarbonate layer 173 on the opposite side, but only one among the first polycarbonate layer 172 and the second polycarbonate layer 173 is (slightly) diffusing, the other not being diffusing.

In a second variant, the reflective polarizer 17 consists of a multilayer optical film 171 fastened by adhesive bonding to a first polycarbonate layer 172 on one side and to a second polycarbonate layer 173 on the opposite side, and the first polycarbonate layer 172 and the second polycarbonate layer 173 are not diffusing.

In a third variant, the reflective polarizer 17 consists of a multilayer optical film 171 fastened by adhesive bonding to a single polycarbonate layer. The single polycarbonate layer may be (slightly) diffusing or non-diffusing.

The optical diffuser 18 comprises a coating layer made of a material sensitive to ultraviolet radiation and capable of adhering to the reflective polarizer 17. The optical diffuser 18 comprises patterns printed in the coating layer. The shape of the printed patterns is defined on the basis of the angular distribution of the optical diffuser 18. For example, the angular distribution of the optical diffuser 18 has a Gaussian profile, the full width at half maximum of which is equal to 30 degrees and 15 degrees in two perpendicular directions, respectively, and with respect to a principal direction of diffusion. For example, the principal direction of diffusion is the direction normal to the plane of the optical diffuser 18.

In other words, a light beam illuminating the optical component 16 and incident on the first polycarbonate layer 172 goes through (in part) the reflective polarizer 17, then the optical diffuser 18 and emerges therefrom in an angularly spread beam, with an angular distribution the full width at half maximum of which is equal, in the example mentioned above, to 30 degrees and 15 degrees in two perpendicular directions, respectively. The shape of the patterns printed in the coating layer thus takes into account the diffusion introduced by the first polycarbonate layer 172 and the second polycarbonate layer 173 in order to obtain the angularly spread beam of 30 degrees and 15 degrees standard deviation in two perpendicular directions.

Generally, the angular distribution of the optical diffuser 18 has a full width at half maximum of less than 45° with respect to the principal direction of diffusion.

The first side of the optical component 16 is positioned facing the reflector 15, which is on the same side as the light source 14. This configuration makes it possible to improve recycling of light inside the backlighting device 10. This is because if a part of the source beam does not have the polarization transmitted by the reflective polarizer, it is reflected by the reflective polarizer 17 and may be re-intercepted by the reflector 15, then again reflected in the direction of the optical component 16.

The liquid-crystal display 11 comprises a liquid-crystal matrix interposed between an upstream polarizer 19 and a downstream polarizer 20, the upstream polarizer 19 being located facing the optical component 16. The upstream polarizer 19 is configured to selectively transmit a light component having an upstream polarization Pa to the liquid-crystal matrix. Suitable activation of certain elements of the liquid-crystal matrix selectively allows passage of the light received from the upstream polarizer 19 via modification of the polarization thereof through the elements of the liquid-crystal matrix and transmission or not through the downstream polarizer 20.

The determined polarization Pd reflected by the reflective polarizer 17 is adjusted to be orthogonal to the upstream polarization Pa. In other words, the polarization of the light Pt transmitted by the reflective polarizer 17 is aligned with the polarization direction transmitted by the upstream polarizer 19 of the liquid-crystal display 11. FIG. 4 schematically illustrates this adjustment.

The beam that emerges from the liquid-crystal display 11 corresponds to the image light beam 7, shown in FIG. 1, generated by the image-generating device 6.

A process for manufacturing the optical component 16 according to the invention will now be described, the main steps of which are shown in FIG. 5.

In a step E0, a coating layer made of a material sensitive to ultraviolet radiation is deposited on a substrate provided with a reflective polarizer comprising a multilayer film (formed of layers of dielectric material). This reflective polarizer here further comprises two (optionally diffusing) polycarbonate layers placed on either side of the multilayer optical film.

It is assumed that the angular distribution of the optical diffuser that it is desired to form on the substrate is predefined, so that the shape of the patterns to be printed in the coating layer may be determined, and that a stamp has been produced based on these patterns.

In a step E2, the stamp is pressed into the coating layer to define the desired patterns.

In a step E4, the stamp still being united with the coating layer, an anneal is carried out in order to set the structure of the patterns in the coating layer. More precisely, the coating layer is illuminated with a beam of ultraviolet rays so as to achieve polymerization (i.e. curing) of the coating layer.

Once the stamp has been detached, the stack obtained is cut to the desired size in order to obtain the optical component 16.

1. A process for manufacturing a backlighting-device component comprising:
depositing a coating layer on a reflective polarizer, said reflective polarizer comprising a multilayer optical film; and
printing patterns in the coating layer in such a way that said printed coating layer forms an optical diffuser.

2. The manufacturing process as claimed in claim 1, wherein the optical diffuser has an angular distribution the full width at half maximum of which is less than 45 degrees with respect to a principal direction of diffusion.

3. The manufacturing process as claimed in claim 1, wherein the coating layer is made of a material that polymerizes under ultraviolet radiation.

4. The manufacturing process as claimed in claim 1, wherein the reflective polarizer further comprises at least one polycarbonate layer deposited on the multilayer optical film.

5. The manufacturing process as claimed in claim 4, wherein the reflective polarizer comprises a further polycarbonate layer, the at least one polycarbonate layer and the further layer being placed on either side of the multilayer optical film.

6. The manufacturing process as claimed in claim 4, wherein the at least one polycarbonate layer is diffusing.

7. The manufacturing process as claimed in claim 6, wherein the at least one polycarbonate layer has a diffusion angle of 2 degrees.

8. The manufacturing process as claimed in claim 4, wherein the at least one polycarbonate layer is adhesively bonded to the multilayer optical film by means of a layer of optical adhesive.

9. The manufacturing process as claimed in claim 1, wherein the dimensions and shape of the patterns are defined on the basis of the angular distribution of the optical diffuser.

10. A backlighting-device component comprising:
a reflective polarizer on a first side, said reflective polarizer comprising a multilayer optical film; and
an optical diffuser on a second side opposite the first side,
wherein the optical diffuser is a coating layer comprising printed patterns.

11. The backlighting-device component as claimed in claim 10, wherein the reflective polarizer further comprises at least one polycarbonate layer deposited on the multilayer optical film.

12. The backlighting-device component as claimed in claim 11, wherein the at least one polycarbonate layer is adhesively bonded to the multilayer optical film by means of a layer of optical adhesive.

13. The backlighting-device component as claimed in claim 11, wherein the reflective polarizer comprises a further polycarbonate layer, the at least one polycarbonate layer and the further layer being placed on either side of the multilayer optical film.

14. The backlighting-device component as claimed in claim 11, to wherein the at least one polycarbonate layer is diffusing.

15. The backlighting-device component as claimed in claim 10, wherein the optical diffuser has an angular distribution the full width at half maximum of which is less than 45 degrees with respect to a principal direction of diffusion.

16. A backlighting device comprising:
a light source configured to emit a source beam,
a reflector configured to reflect at least a part of the source beam into a reflected beam,
a component as claimed in claim 10,
wherein the first side of the component is placed facing the light source so as to intercept at least a part of the reflected beam.

17. An image-generating device comprising a backlighting device as claimed in claim 16, wherein it further comprises a liquid-crystal display placed downstream of the reflector on the path of propagation of the light.

18. A head-up display comprising an image-generating device as claimed in claim 17, further comprising a projecting optical system able of steering a light beam generated by the image-generating device in the direction of a partially transparent blade.
